(19) United States
(12) Patent Application Publication
(10) Pub. No.: US 2010/0296583 A1
(43) Pub. Date: Nov. 25, 2010

(54) IMAGE PROCESSING AND TRANSMISSION IN A KVM SWITCH SYSTEM WITH SPECIAL HANDLING FOR REGIONS OF INTEREST

(75) Inventor: Wenshun Li, Richmond (CA)

Correspondence Address: Chen Yoshimura LLP;Attention Ying Chen, 333 W. El Camino Real, Suite 380, Sunnyvale, CA, 94087, US

(73) Assignee: ATEN INTERNATIONAL CO., LTD., Taipei (TW)

(21) Appl. No.: 12/471,250

(22) Filed: May 22, 2009

(51) Int. Cl. H04N 7/26; G06K 9/34

(52) U.S. Cl. 375/240.24; 375/240.26; 382/173; 375/E07.2

(57) ABSTRACT

In server-client system, such as an IKVM, where a server and a client are connected via a network, an ROI (region of interest) function is provided which allows an ROI area of the video image displayed on the client to have higher image quality and/or magnification than the rest of the image. The client defines an ROI area and transmits the ROI parameters to the server. The server processes video data in the ROI area and non-ROI area differently in various stages of video data processing, including video data sampling/scaling, processing, compression, and transmission, so that the image in the ROI area has a higher image quality and/or magnification. The client may also cooperate with the server to accomplish the ROI function, such as by performing image enhancement processing of the ROI area during image display.

### BACKGROUND OF THE INVENTION

1. Field of the Invention

This invention relates to image data processing and transmission in a KVM (keyboard, video, mouse) switch system, and in particular, it relates to a method and system which performs special image data processing and transmission for region of interest.

2. Description of the Related Art

A KVM (keyboard, video, mouse) switch system is a system in which multiple computers are connected to one or more user consoles by a KVM switch device. Each user console typically includes a monitor and a set of user input devices such as a keyboard and a mouse. Each user console can selectively communicate with one or more of the computers connected to the KVM switch. In a KVM over IP system (sometimes referred to as IKVM system), the user consoles are connected to the KVM switch via a network such as the Internet, a WAN, a LAN, etc. In an IKVM system, the user console is typically connected to a client computer which is connected to the network. The computers connected to the IKVM switch are referred to as the remote computers.

In an IKVM system, the video images from the remote computers (e.g. desktop images of the remote computers) are transmitted to the client computer for display on its monitor. The bandwidth of the data transmission is often limited by the network or other transmission linkages in the system. Thus, conventional IKVM systems often have low image quality when the images from the remote computers are displayed on the client's monitor. This problem is particularly severe when the IKVM system is in a “TV wall” mode, where the desktop images of multiple remote computers are displayed simultaneously on the client's monitor. In such a mode, each desktop image is typically scaled down so the image size is smaller. Thus, the quality of the image displayed on the client's monitor is often poor.

### SUMMARY OF THE INVENTION

Accordingly, the present invention is directed to a system and related method for generating, transmitting and displaying images on a client computer where an ROI (region of interest) is handled differently which substantially obviates one or more of the problems due to limitations and disadvantages of the related art.

An object of the present invention is to allow the user in an IKVM system to see regions of the images more clearly on the client computer even when the network bandwidth is limited.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, the present invention provides a method performed in a server-client system which includes a server and a client connected via a network, the method including a process performed by the server, which includes: (a) receiving ROI (region of interest) commands from the client which indicate activation of an ROI function and define an ROI area; (b) processing an input video data to generate processed video data, wherein the input video data within the ROI area is processed differently from the input video data outside of the ROI area, the processed video data within the ROI area having a higher quality and/or magnification than the processed video data outside of the ROI area; and (c) transmitting the processed video data to the client.

In another aspect, the present invention provides a server in a server-client system where the server is connected to a client via a network, the server comprising a processor programmed to execute a process for processing video data and transmitting the processed video data to the client via the network, the process comprising: (a) receiving ROI (region of interest) commands from the client which indicate activation of an ROI function and define an ROI area; (b) processing an input video data to generate processed video data, wherein the input video data within the ROI area is processed differently from the input video data outside of the ROI area, the processed video data within the ROI area having a higher quality and/or magnification than the processed video data outside of the ROI area; and (c) transmitting the processed video data to the client.

It is to be understood that both the foregoing general description and the following detailed description are exemplary and explanatory and are intended to provide further explanation of the invention as claimed.

### BRIEF DESCRIPTION OF THE DRAWINGS

FIG. 1 schematically illustrates an IKVM system in which embodiments of the present invention are implemented.

FIG. 2 schematically illustrates an IKVM server of the IKVM system of FIG. 1 in which embodiments of the present invention are implemented.

FIGS. 3A and 3B schematically illustrates a screen display with ROI functions.

FIG. 4a illustrates a process performed by the client computer for activating an ROI function.

FIG. 4b illustrates a process performed by the server computer for processing and transmitting video image data to different users with the ROI function turned on or off.

FIGS. 5, 6, and 7 illustrate processes performed by the IKVM server for implementing an ROI function. FIG. 5 shows an image processing stage; FIG. 6 shows an image compression stage, and FIG. 7 shows an image sampling stage.

FIG. 8 illustrates an overall process of implementing an ROI function according embodiments of the present invention.

### DETAILED DESCRIPTION OF THE PREFERRED EMBODIMENTS

As required, a detailed illustrative embodiment of the present invention is disclosed herein. However, techniques, systems and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein, which define the scope of the present invention. The following presents a detailed description of the preferred embodiment (as well as some alternative embodiments) of the present invention.

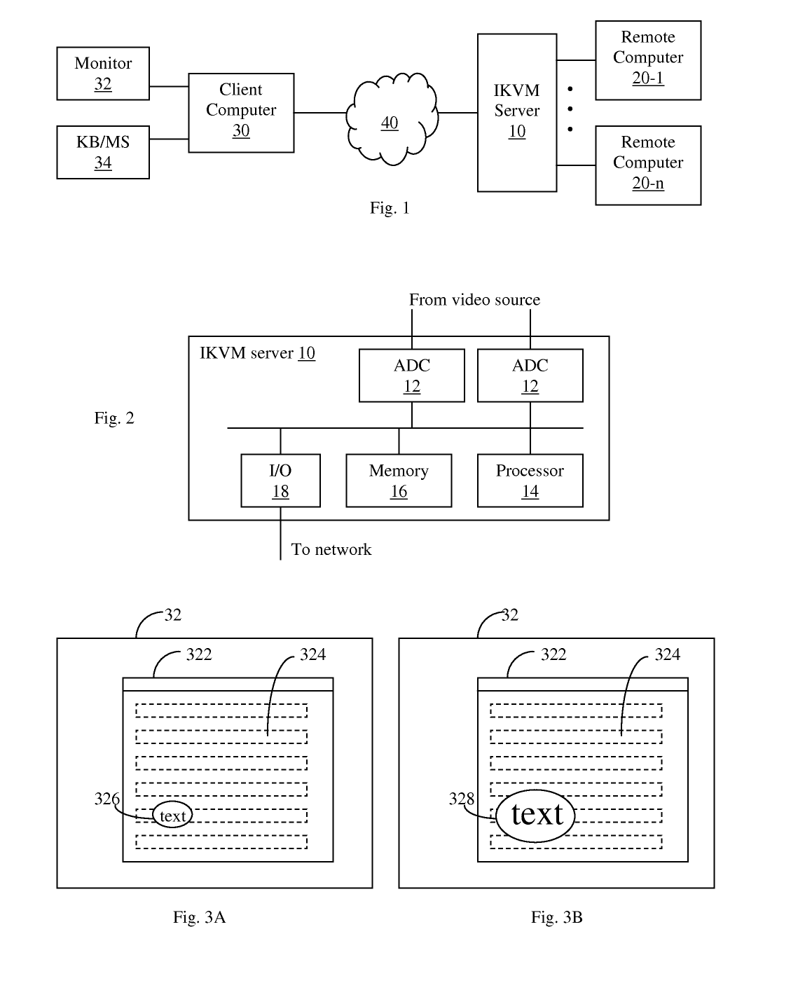

FIG. 1 schematically illustrates an IKVM system in which embodiments of the present invention are implemented. A plurality of remote computers 20-1 to 20-n are connected to an IKVM switch (also referred to as IKVM server) 10, which is connected to a network 40. A client computer 30 is also connected to the network 40. A user console is connected to the client computer 30. The user console may include, for example, a monitor 32 and a set of user input devices 34 such as a keyboard and a mouse.

Embodiments of the present invention provide a method and related apparatus in the IKVM system for displaying selected areas of the video image with higher image quality on the monitor 32 of the client computer 30. The user at the client computer 30 can select a desired area, referred to herein as the region of interest (ROI), and the IKVM server 10 will process and transmit the video data in a way so that the image in the ROI has a higher image quality and/or magnification. The ROI function, i.e. the display of the ROI areas with higher image quality and/or magnification, can be accomplished by modifying various steps of video data processing by the IKVM server 10, such as video data sampling, processing, compression, and transmission as will be described in more detail later. The client computer 30 may also cooperate with the IKVM server 10 to accomplish the ROI function, such as performing image enhancement processing of the ROI area during image display as will be described in more detail later.

FIG. 2 illustrates the structure of the IKVM server 10. The IKVM server 10 includes a plurality of analog-to-digital converters (ADCs) 12 for converting video signals from the video source (remote computers) to digital video image data. A processing section 14 performs various image processing on the digital video image data, including compression, scaling, etc. The processing section 14 may be implemented by microprocessor(s) executing image processing firmware for software, or logic circuits such as ASICs, or combinations thereof. One or more memories 16 are provided to buffer the data during processing. An I/O section 18 transmits the processed image data to the client computer over the network. The ADCs 12, the processing section 14, the memory 16 and the I/O section 18 are connected to each other by a bus. The IKVM switch may also includes (not shown in the figure) other appropriate components commonly found in conventional KVM switches, such as a switching element for selecting video signals from one or more remote computers for processing, a switching element for transmitting the user input signals from the client computer a selected remote computer, a control section for controlling the operation of the IKVM switch, etc.

FIG. 3A schematically illustrates an image displayed on the monitor 32, showing a window 322 with image items (lines of text, icons, etc.) 324 having a normal image quality. The image items in the ROI 326 are displayed at their normal size but with a higher image quality. In this disclosure, the term “image quality” broadly encompasses various properties that affect visual quality of the image, which can be affected by various factors such as spatial resolution of the image data, color depth of the image data, whether the image has been compressed with high or low compression quality, whether the image data has gone through various image enhancement processing such as edge enhancement, etc.

FIG. 3B shows an image displayed on the monitor 32, showing a window 322 with image items 324 having a normal image quality and an ROI 328. The ROI 328 displays a magnified view of the underlying image. It should be noted that magnification here refers to a larger scale relative to other areas of the image; it does not necessarily mean that the image in the ROI is magnified with respect to the original image of the video source. For example, in some cases such as a TV wall application, the images displayed on the monitor may be a reduced-scale version of the original image of the video source and the ROI may be displayed at the original image scale. It should be noted that due to magnification, the ROI 328 does not display the entirety of the original image in the ROI but only a portion of it. Preferably, the magnified image in the ROI 328 is also displayed with a higher image quality.

The ROI area is designated by the user using the input device 34, such as the mouse. The ROI are may have any suitable size and shape. Various user interface (UI) tools may be used to activate the ROI function and designate the ROI area. In one example, a “magnifying glass” icon is displayed on the screen and the user is allowed to move the magnifying glass using the mouse. In another example, the user performs click and drag using the mouse to define an area on the screen as the ROI. Other suitable user interface methods may be used to define the ROI.

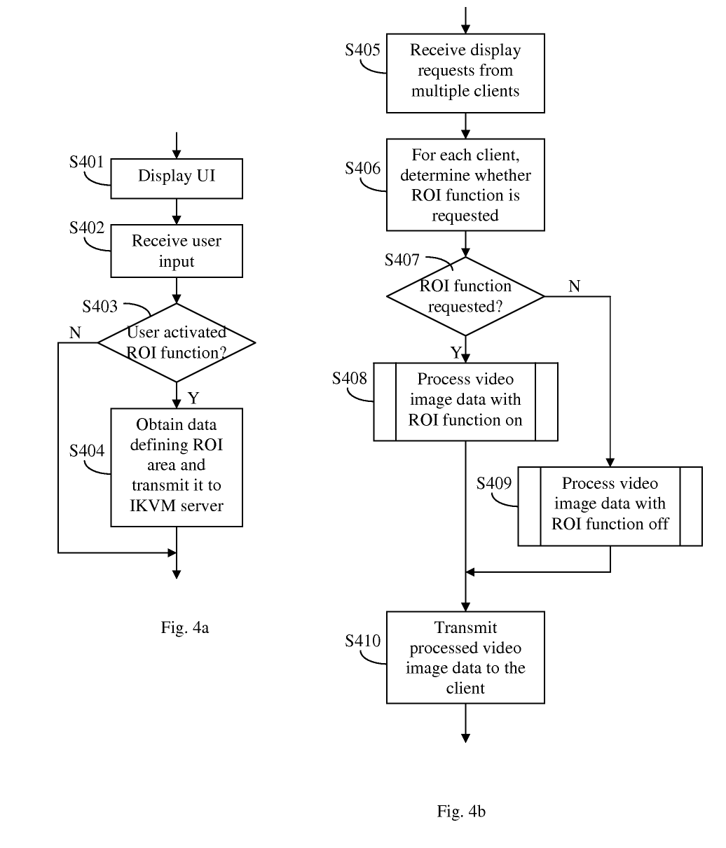

FIG. 4a illustrates a process performed by the client computer 30 for activating an ROI function and designating the ROI area. The client computer includes a processor that executes stored software or firmware programs to perform this function. First, the client computer displays a UI to allow the user to activate the ROI function and define the ROI area (step S401). The client computer receives a user input (step S402), and determines whether the user has activated the ROI function (step S403). If the user has (“Y” in step S403), the client computer obtains parameters defining the ROI mode and ROI area as inputted by the user, and transmits the ROI parameters (along with a command that indicates that ROI is activated) to the IKVM server 10 via the network (step S404). In one implementation, the UI allows the user to continuously move a UI tool (such as a magnifying glass) on the screen; in such a case, the step S404 continuously obtains the ROI parameters and continuously transmits them to the IKVM server. Once the ROI function is de-activated, the process continues to other functions of the client computer. If in step S403 the user did not activate the ROI function, the step S404 is not performed. Optionally, the client computer may transmit a command to the IKVM server indicating that the ROI function is not activated.

The ROI parameters in step S404 may be in any appropriate form so long as they define the location, size and shape of the ROI. For example, if the ROI is a rectangle, the ROI parameters may include coordinates of two corners of the rectangle. If the ROI is an oval shape, the ROI parameters may include a shape index, a size and coordinate of the center of the oval. The ROI parameters also identify the ROI mode, such as high quality only, high quality with magnification, etc.

FIG. 4b illustrates a process executed by the server for processing video image data and transmitting the data to different clients. The server may be connected to multiple clients and receive display request from multiple clients. Sometimes, multiple clients may request to display video image data from the same video source but some client may request ROI function and some clients do not. In step S405, the server receives display requests from multiple clients. For each client, the server determines whether the client requests ROI function (step S406). If the client requests the ROI function (“Y” in step S407), the server processes the video image data with the ROI function turned on (step S408); otherwise (“N” in step S407) the server processes the video image data without the ROI function turned on (step S409). The server then transmits the processed video data to the client (step S410). The video image processing is performed for each client; or, if some clients request the same video data, then the same processed video image data may be transmitted to these clients.

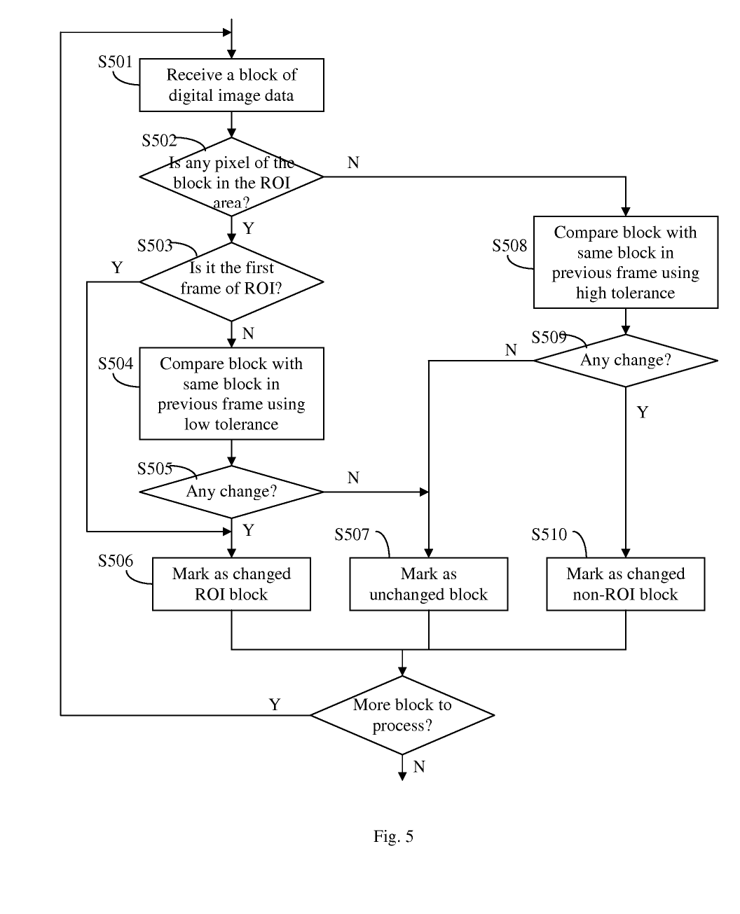

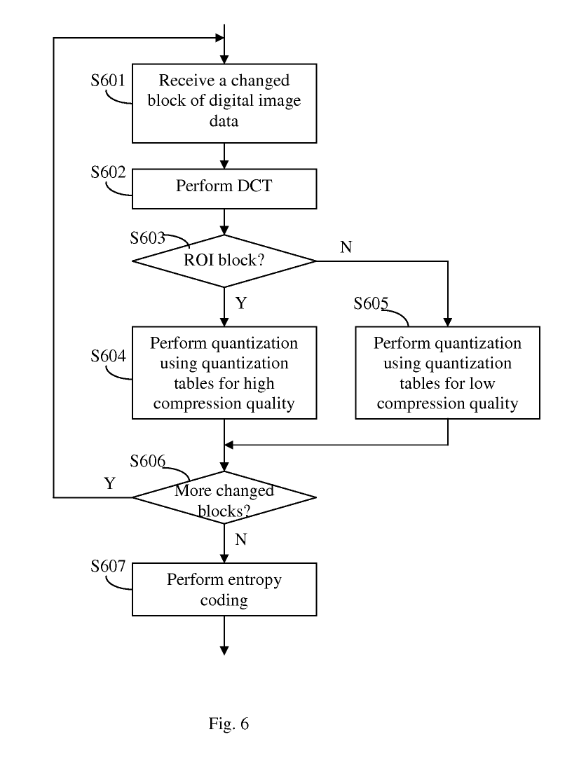

FIGS. 5 and 6 illustrate a process executed by the processing section 14 of the IKVM server 10 for implementing an ROI function. The processing section 14 receives input digital image data, which is generated by the ADC 12. The image is process one block at a time, where the block size may be, for example, 16 by 16 pixels. FIG. 5 is a process for identifying whether a block is a changed ROI block, a changed non-ROI or an unchanged block, based on comparison with the previous frame of image.

At the start of the process of FIG. 5, the processing section 14 has received the command from the client computer indicating that that ROI is activated, as well as the ROI parameters. For each block of digital image data received (step S501), the processing section 14 determines whether any pixel of the block falls within the ROI area (step S502). In other words, this step determines whether the block overlaps with the ROI area or not. If the answer is Yes (“Y” in step S502), the processing section 14 determines whether the current frame is the first frame after the ROI function was activated (step S503). If it is (“Y” in step S503), the current block is marked as a “changed ROI block” (step S506).

If the current frame is not the first frame after the ROI function was activated (“N” in step S503), the processing section 14 compares the block with the same block (i.e. same location in the image) in the previous frame using a lower tolerance to detect any changes in the block (step S504). Lower tolerance means that relatively small changes will be detected as compared to a comparison using a higher tolerance. If any change is detected (“Y” in step S505), the block is again marked as a “changed ROI block” (step S506). If no change is detected (“N” in step S505), the block is marked as an “unchanged block” (step S507).

In step S502, if none of the pixels of the block falls within the ROI area (“N” in step S502), the processing section 14 compares the block with the same block in the previous frame using a higher tolerance to detect any changes in the block (step S508). If no change is detected (“N” in step S509), the block is marked as an “unchanged block” (step S507). If any change is detected (“Y” in step S509), the block is marked as a “changed non-ROI block” (step S510). After the block is marked in steps S506, S507 or S510, the next block (if any) is processed by repeating steps S501 to S510.

FIG. 6 is a JPEG compression process for compressing data blocks that have been marked as changed ROI blocks or changed non-ROI blocks by the processed of FIG. 5. Data blocks that are marked as unchanged in the process of FIG. 5 are not JPEG processed. In one implementation, unchanged data blocks are not transmitted to the client in order to reduce the data transmission burden. At the client side, only changed parts of the video image are updated. According to the process of FIG. 6, changed ROI blocks are compressed with higher quality, such as by using quantization tables for higher quality compression, as compared to the changed non-ROI blocks.

As shown in FIG. 6, after receiving a changed block of digital image data (step S601), the processing section 14 performs DCT (discrete cosine transform) on the image data to generate transform coefficients (step S602). Note that DCT is typically performed on 8 by 8 blocks of data. After DCT, if the block is an ROI block (“Y” in step S603), the DCT coefficients are quantized using quantization tables for higher compression quality (step S604); otherwise (“N” in step S603), the DCT coefficients are quantized using quantization tables for a lower compression quality (step S605). Subsequently, the quantized DCT coefficients are entropy coded (step S607), e.g., by Huffman coding. This process (DCT, quantization and entropy coding) is repeated for all changed blocks. Note that while step S607 is shown in FIG. 6 as being outside of the decision loop (step S606), it can also be inside of the loop. The JPEG compressed data is transmitted to the client via the network for display. Although JPEG compression is described here, the digital image data may also be compressed using MPEG or other compression method.

To summarize, in the process shown in FIGS. 5 and 6, blocks of digital image data that overlap with the ROI area are detected for changed with lower tolerance and then processed with higher compression quality, while blocks of digital image data that do not overlap with the ROI area are detected for change with higher tolerance and then processed with lower compression quality. At the client side, the compressed image data is decompressed and displayed. As a result, the image within the ROI area has higher quality than images outside of the ROI area. This result corresponds to the effect shown in FIG. 3A.

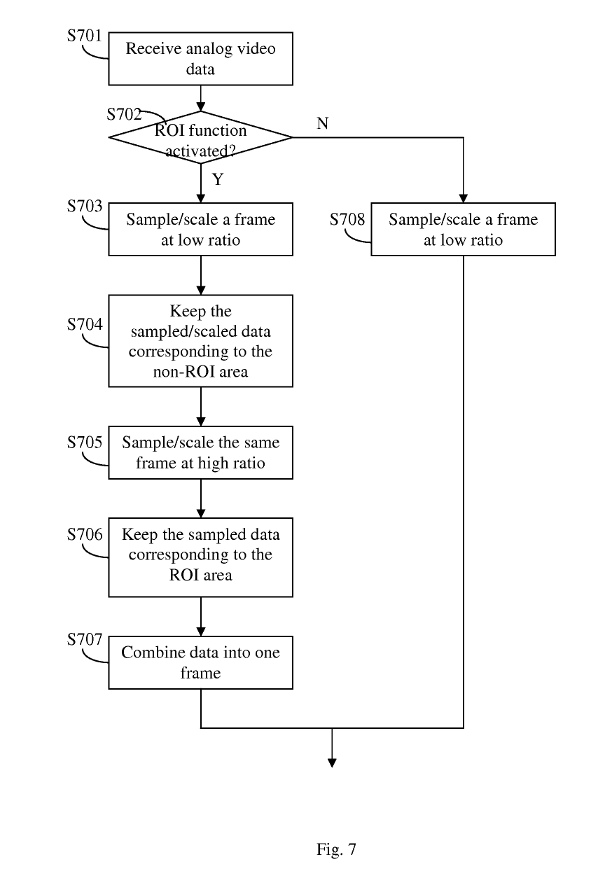

FIG. 7 illustrates another process of implementing an ROI function according to another embodiment of the present invention. This process may be used, for example, in a “TV wall” mode where the desktop images of multiple remote computers are reduced in size and displayed simultaneously on the client's monitor. In this implementation, each frame of analog video data is sampled at two different sampling ratios, one for data in the non-ROI area (which may be referred to as the TV wall data) and one for data in the ROI area, and the sampled data are combined to form one frame. The sampling processing shown in FIG. 7 is performed by the ADC 12.

As shown in FIG. 7, the ADC 12 receives analog video data from a video source (a remote computer 20-i) (step S701). If the ROI function is activated (“Y” in step S702), the ADC 12 samples and/or scales the frame at a lower ratio (step S703), and keeps the sampled/scaled data corresponding to the non-ROI area (step S704). The ADC 12 also samples/scales the frame a second time at a higher ratio (step S705), and keep the sampled/scaled data corresponding to the ROI area (step S706). The two sampling/scaling steps may be performed in parallel by two sets of hardware. Then, TV wall data kept in step S704 and the ROI data kept in step S706 are combined into one frame (step S707), which includes non-ROI areas having been sampled/scaled at the lower ratio and the ROI area having been sampled/scaled at the higher ratio. This results in the image in the ROI being magnified relative to the other areas. If in step S702 the ROI function is not activated (“N” in step S702), the video data is sampled/scaled at the lower ratio only (step S708).

The description above refers to “sampling/scaling” a frame. In implementation, the sampling and/or scaling steps may be done in one step or separate steps, depending on the implementation of the ADC hardware. If the ADC hardware supports sampling a frame at different sampling ratios for different areas within the frame, then steps S703 to S707 can be performed in on step by the ADC hardware, without the need to sample the frame twice. Scaling by firmware/software is optional in this case and is usually not performed.

In an alternative implementation, if the ADC hardware supports sampling whole frames at different sampling ratios, then each frame can be sampled two times with two different sampling ratios in steps S703 and S705, respectively. Scaling by firmware/software is optional in this case and is usually not performed as a part of steps S703 and S705. The firmware/software combines the two sampled frame images as one frame image in step S707.

In another alternative implementation, the ADC hardware samples each frame only once at one sampling ratio, and the firmware/software scales the sampled frame twice with two different scaling ratios. In this case, step S703 includes sampling the frame and scaling it at a first scaling ratio (scaling is optional here), and step S705 includes scaling the previously sampled frame at a second scaling ratio. The end results of these three implementations are the same, which is one frame of image in which the ROI has a higher sampling or scaling ratio than the rest of the frame.

The frames of data generated by the process of FIG. 7 are further processed by the processing section 14 to identify changed data blocks (the same process as shown in FIG. 5) and to compress the data (the same process as shown in FIG. 6). If the ROI function is being performed in the TV wall mode, the video images from other remote computers are similarly processed, and the images from multiple remote computers are combined into one image before carrying out the processes of FIGS. 5 and 6.

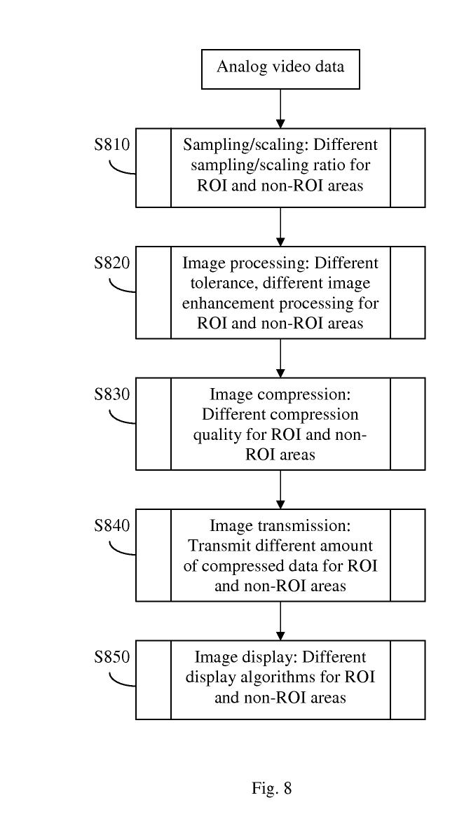

FIG. 8 is a more general illustration of the overall processes of implementing an ROI function according embodiments of the present invention. To implement the ROI function, the data in the ROI area and non-ROI area are treated differently during various processing stages. In the analog video data sampling/scaling stage (step S810), the ROI area is sampled and/or scaled at a higher ratio and the non-ROI area is sampled and/or scaled at a lower or normal ratio. The process shown in FIG. 7 or the alternatives described earlier may be used to implement this stage.

After sampling/scaling, the digital image data undergoes an image processing stage (step S820). In this stage, comparison with previous frame is done using a lower tolerance for the ROI area and a higher or normal tolerance for the non-ROI area. The process shown in FIG. 5 may be used to implement this stage. In addition, certain image enhancement processing may be applied to the ROI area only, such as noise reduction using a Gaussian filter, edge enhancement and image edge extraction using a Sobel operator, etc. These image enhancement techniques are generally known in the art. For more details of these techniques, the reader may refer to, for example, Sindoukas, D., Laskaris, N., and Fotopoulos, S., “Algorithms for color image edge enhancement using potentialfunctions”, Signal Processing Letters, IEEE, Volume 4, Issue 9, September 1997 Page(s): 269-272; and Deng, G. and Cahill, L. W., “An adaptive Gaussian filter for noise reduction and edge detection”, Nuclear Science Symposium and Medical Imaging Conference, 1993, 1993 IEEE Conference Record, 31 Oct.-6 Nov. 1993, Page(s): 1615-1619 vol. 3

In the image compression stage (step S830), the ROI area is compressed with a higher compression quality and the non-ROI area is compressed with a lower or normal compression quality. The process shown in FIG. 6 may be used to implement this stage. In the example shown in FIG. 6, different compression qualities are achieved by using different quantization tables. In other examples, the ROI area may be compressed using a lossless compression method, or it may be uncompressed to achieve higher image quality. The ROI area and non-ROI area may be compressed using different compression methods. In this disclosure, “higher compression quality” broadly encompasses lossless compression and no compression since the normal compression applied to non-ROI area is a lossy compression.

In the image transmission stage (step S840), if the compression algorithm used in step S830 supports progressive transmission, then more compression data is transmitted for the ROI area than the non-ROI area. One example of a compression algorithm that supports progressive transmission is multiresolution decomposition using discrete wavelet transform. According to this method, the chrominance and/or luminance signals of the image undergo a multiresolution decomposition to generate a plurality of decomposition components at different resolution levels for each of the signals. The IKVM server transmits more decomposition components for the ROI and fewer decomposition components for the non-ROI area. Commonly owned U.S. patent application entitled “Multi-channel KVM server system employing multiresolution decomposition”, attorney docket no. 72836.7071, describes such a method in more detail.

The above data processing stages S810 to S840 are performed by the IKVM server 10. The implementing an ROI function may also involve different treatment of the data in the ROI and non-ROI areas during the image display stage (step S850), which is performed by the client computer 30. On the client 30, after decompression, image enhancement processing may be applied to data in the ROI area only to enhance the image quality for the ROI area. The image enhancement processing may include image scaling, noise reduction using a Gaussian filter, edge enhancement and image edge extraction using a Sobel operator, etc.

The ROI function described here has many advantages. First, when the network bandwidth is relatively low and the displayed image or video as a whole has a relatively low image quality, the ROI are can have much better image quality and is much clearer. The user can select the ROI area at will to examine its content. In the TV wall mode, when the images from multiple remote computers are scaled down, the ROI can be magnified and made more clearly visible. Second, clearer image in the ROI area can be provided without significantly increasing the amount of data transmission. This is because the majority of the data are processed and transmitted at their normal quality. Third, since the entire image is not magnified, the entire images still fits in the display window as if the ROI mode is not activated. The ROI function is more convenient than a conventional zoom function where the entire image is magnified, because the magnified image will typically not fit in the display window and the user will have to drag the mouse to see different parts of the zoomed image. The ROI function is also more convenient than a conventional clip function, where a particular area of the image is magnified and fills the entire display window, because clipping discards the portions of the image not clipped. Both conventional zooming and clipping functions typically require a relatively high transmission bandwidth because the entire image displayed on the display screen is high quality or magnified.

Although the ROI functions are described here in the context of an IKVM system, their application is not limited to an IKVM system. More generally, the ROI function can be implemented in any server-client system where the server and client are connected by a network. The ROI function can also be used in other practical fields, such medical imaging systems, etc., where images are transmitted from a server to a client via a network.

It will be apparent to those skilled in the art that various modification and variations can be made in the ROI function and related apparatus of the present invention without departing from the spirit or scope of the invention. Thus, it is intended that the present invention cover modifications and variations that come within the scope of the appended claims and their equivalents.

What is claimed is:

1. A method performed in a server-client system which includes a server and a client connected via a network, the method including a process performed by the server, comprising:
(a) receiving ROI (region of interest) commands from the client which indicate activation of an ROI function and define an ROI area;
(b) processing an input video data to generate processed video data, wherein the input video data within the ROI area is processed differently from the input video data outside of the ROI area, the processed video data within the ROI area having a higher quality and/or magnification than the processed video data outside of the ROI area; and
(c) transmitting the processed video data to the client.

2. The method of claim 1, wherein in step (b), the input video data is analog video data, and wherein step (b) includes:
(b1) sampling the analog video data to generate frames of digital video data;
(b2) dividing each frame of digital video data into a plurality of blocks of data and identifying blocks that have changed as compared to a previous frame; and
(b3) compressing at least the blocks of data that have changed to generate the processed video data.

3. The method of claim 2, wherein in step (b1), the analog video data is sampled and/or scaled at a first ratio within the ROI area and sampled and/or scaled at a second ratio outside of the ROI area, the first ratio being higher than the second ratio.

4. The method of claim 2, wherein step (b2) comprises:
dividing each frame of digital video data into a plurality of blocks;
for each block, determining whether the block overlaps with the ROI area;
if the block overlaps with the ROI area, comparing the block to a corresponding block in the previous frame using a first tolerance to determine whether the block has changed; and
if the block does not overlap with the ROI area, comparing the block to a corresponding block in the previous frame using a second tolerance to determine whether the block has changed, wherein the first tolerance is lower than the second tolerance.

5. The method of claim 2, wherein step (b3) comprises:
for each changed block, determining whether the block overlaps with the ROI area;
if the block overlaps with the ROI area, compressing the block at a first compression quality; and
if the block does not overlap with the ROI area, compressing the block at a second compression quality, wherein the first compression quality is higher than the second compression quality.

6. The method of claim 2, wherein step (b3) comprises:
for each changed block, determining whether the block overlaps with the ROI area;
if the block overlaps with the ROI area, compressing the block using JPEG compression with a first set of quantization tables; and
if the block does not overlap with the ROI area, compressing the block using JPEG compression with a second set of quantization tables, wherein the first set of quantization tables generate higher compression quality than the second set of quantization tables.

7. The method of claim 2, wherein step (b) further comprises, after step (b2) and before step (b3):
(b4) for each changed block, performing image enhancement processing only if the block overlaps with the ROI area.

8. The method of claim 2, wherein step (b3) includes compressing the blocks of data by a multiresolution decomposition method using discrete wavelet transform to generate a plurality of decomposition components at different resolution levels, and
wherein step (c) includes transmitting a first number of decomposition components for the blocks that overlap with the ROI area and transmitting a second number of decomposition components for the blocks that do not overlap with the ROI area, wherein the first number is higher than the second number.

9. The method of claim 1, further including a process performed by the client, comprising:
(d) generating and transmitting the ROI commands to the server; and
(e) displaying the video data received from the server.

10. The method of claim 9, wherein step (d) includes:
(d1) displaying a user interface (UI) on a display;
(d2) receiving a user input via a user input device; and
(d3) obtaining ROI parameters defining a size and shape of the ROI area based on the user input.

11. The method of claim 9, wherein step (e) includes performing image enhancement processing on the received video data within the ROI area.

12. A server in a server-client system where the server is connected to a client via a network, the server comprising a processor programmed to execute a process for processing video data and transmitting the processed video data to the client via the network, the process comprising:
(a) receiving ROI (region of interest) commands from the client which indicate activation of an ROI function and define an ROI area;
(b) processing an input video data to generate processed video data, wherein the input video data within the ROI area is processed differently from the input video data outside of the ROI area, the processed video data within the ROI area having a higher quality and/or magnification than the processed video data outside of the ROI area; and
(c) transmitting the processed video data to the client.

13. The server of claim 12, further comprising an analog to digital converter for sampling an analog video signal to generate the input video data, wherein the analog video signal is sampled and/or scaled at a first ratio within the ROI area and sampled and/or scaled at a second ratio outside of the ROI area, the first ratio being higher than the second ratio.

14. The server of claim 12, wherein the input video data includes frames of digital video data, wherein step (b) includes:
(b1) dividing each frame of digital video data into a plurality of blocks of data and identifying blocks that have changed as compared to a previous frame; and
(b2) compressing at least the blocks of data that have changed to generate the processed video data.

15. The server of claim 14, wherein step (b1) comprises:
dividing each frame of digital video data into a plurality of blocks;
for each block, determining whether the block overlaps with the ROI area;
if the block overlaps with the ROI area, comparing the block to a corresponding block in the previous frame using a first tolerance to determine whether the block has changed; and
if the block does not overlap with the ROI area, comparing the block to a corresponding block in the previous frame using a second tolerance to determine whether the block has changed, wherein the first tolerance is lower than the second tolerance.

16. The server of claim 14, wherein step (b2) comprises:
for each changed block, determining whether the block overlaps with the ROI area;
if the block overlaps with the ROI area, compressing the block at a first compression quality; and
if the block does not overlap with the ROI area, compressing the block at a second compression quality, wherein the first compression quality is higher than the second compression quality.

17. The server of claim 14, wherein step (b2) comprises:
for each changed block, determining whether the block overlaps with the ROI area;
if the block overlaps with the ROI area, compressing the block using JPEG compression with a first set of quantization tables; and
if the block does not overlap with the ROI area, compressing the block using JPEG compression with a second set of quantization tables, wherein the first set of quantization tables generate higher compression quality than the second set of quantization tables.

18. The server of claim 14, wherein step (b) further comprises, after step (b1) and before step (b2):
(b3) for each changed block, performing image enhancement processing only if the block overlaps with the ROI area.

19. The server of claim 14, wherein step (b2) includes compressing the blocks of data by a multiresolution decomposition method using discrete wavelet transform to generate a plurality of decomposition components at different resolution levels, and
wherein step (c) includes transmitting a first number of decomposition components for the blocks that overlap with the ROI area and transmitting a second number of decomposition components for the blocks that do not overlap with the ROI area, wherein the first number is higher than the second number.

20. A system comprising:
a server; and
a client including a display device, the server and the client being connected via a network,
wherein the server includes a processor programmed to execute a process for processing video data and transmitting the processed video data to the client via the network, the process comprising:
receiving ROI (region of interest) commands from the client which indicate activation of a ROI function and define an ROI area;
processing an input video data to generate processed video data, wherein the input video data within the ROI area is processed differently from the input video data outside of the ROI area, the processed video data within the ROI area having a higher quality and /or magnification than the processed video data outside of the ROI area; and
transmitting the processed video data to the client;
wherein the client includes a processor programmed to execute a process comprising:
generating the ROI commands based on user inputs and transmitting the ROI commands to the server; and
receiving the processed video data from the server and displaying the video data on the display device.
